(19) United States
(12) Patent Application Publication
(10) Pub. No.: US 2014/0067663 A1
(43) Pub. Date: Mar. 6, 2014

(54) METHOD FOR THE PREVENTION OF MONEY LAUNDERING ATTACKS

(71) Applicant: Wincor Nixdorf International GmbH, Paderborn (DE)

(72) Inventors: Christian STARKE, Paderborn (DE); Thorsten NEUMANN, Paderborn (DE)

(73) Assignee: Wincor Nixdorf International GmbH, Paderborn (DE)

(21) Appl. No.: 14/017,092

(22) Filed: Sep. 3, 2013

(30) Foreign Application Priority Data
Sep. 4, 2012 (EP) 12 183 028.5

(51) Int. Cl. G06Q 20/40

(52) U.S. Cl. CPC G06Q 20/4016
USPC 705/39

(57) ABSTRACT

In a method for the prevention of money laundering attacks at a payment device, a control means of a payment device determines a first amount to be paid in connection with a payment operation, a second amount is paid by a user at a paying means of the payment device by delivery of cash, and the control means detects the paid, second amount. It is provided that the control device evaluates the payable, first amount and/or the paid, second amount with reference to at least one monitoring criterion, infers a possible money laundering attack in dependence on the evaluation, and initiates a countermeasure. In this way, there is indicated a method for the prevention of money laundering attacks which in a simple, inexpensive way and, if possible, without any expensive constructional changes of payment devices provides for a prevention of money laundering attacks.

### CROSS-REFERENCE TO RELATED APPLICATION

This application claims the benefit of European Patent Application No. 12 183 028.5 filed on Sep. 4, 2012, the entirety of which is fully incorporated herein by reference.

### BACKGROUND

This invention relates to a method for the prevention of money laundering attacks of a payment device and to a payment device for carrying out a payment operation for carrying out a method for the prevention of money laundering attacks.

In such method, a control means of a payment device determines a first amount to be paid in connection with a payment operation. A second amount is paid by a user at a paying means of the payment device by delivery of cash. The control means detects this paid, second amount.

Such payment device for example can be a so-called self-checkout machine, at which a customer e.g. in a retail shop can pay goods automatically. For this purpose, the goods are detected at the payment device for example via a suitable scanning device, in order to therefrom determine the amount to be paid. The amount to be paid is displayed to the customer, and the customer makes the payment e.g. by inserting coins or by inserting bank notes, i.e. by payment of cash. A control means detects the paid amount and for example determines whether the paid amount is sufficient.

In principle, however, such payment device also can be other devices at which a payment can be made by means of cash. For example, the payment device also can be a coin-operated telephone, a ticket machine, a drinks dispenser or other merchandise vending machine (e.g. a so-called vending machine) or the like.

In principle, it is also possible at such payment devices to make a payment in a cashless manner by means of a credit or debit card. In this connection, however, the present invention relates to the payment by means of cash.

The delivery of cash in this connection is understood to be the insertion of coins or the insertion of bank notes at a paying means determined for this purpose, for example a coin insertion means or a bank note insertion means.

At payment devices, money laundering attacks can occur. In connection with such money laundering attacks it is attempted to exchange counterfeit money—i.e. counterfeit coins or counterfeit bank notes—against real money, for example by inserting counterfeit coins or counterfeit bank notes at a payment device, in order to receive change in the form of real coins and/or real bank notes. In this way, for example, a comparatively lower amount to be paid can be paid by means of a relatively very much greater amount, so as to receive a large amount of change and hence a large amount of real money.

At payment devices, the authenticity of coins and bank notes conventionally is checked for the prevention of money laundering attacks, in that for example inserted coins are checked inductively or bank notes are examined with reference to safety features. However, this can be expensive and possibly insecure, because e.g. foreign or counterfeit coins, which employ a similar material as genuine coins, cannot be recognized with sufficient safety.

In a method for checking a money laundering risk, which is known from U.S. Pat. No. 7,805,362, different risk factors are taken into account, for example a product risk or local and personal risk attributes. In this connection, however, U.S. Pat. No. 7,805,362 does not refer to the monitoring of a concrete pay-in operation at a payment device.

With respect to a coin processing means of a payment device, DE 10 2007 024 301 A1 describes that inserted coins also are issued again with a return of cash, so that a money laundering risk is at least reduced.

### SUMMARY

It is the object of the present invention to indicate a method for the prevention of money laundering attacks and a payment device for carrying out such method, which in a simple, inexpensive way and, if possible without expensive constructional changes of payment devices provides for a prevention of money laundering attacks.

According to an exemplary embodiment of the invention the control device evaluates the payable, first amount and/or the paid, second amount with reference to at least one monitoring criterion, infers a possible money laundering attack in dependence on the evaluation, and initiates a countermeasure.

The present invention proceeds from the idea to eliminate the risk of a money laundering attack by evaluating the payable, first amount and/or the paid, second amount. The evaluation is effected with reference to predetermined monitoring criteria, by means of which the payable, first amount and/or the paid, second amount, are checked, in order to evaluate the risk of a money laundering attack in dependence on the result of this examination and possibly initiate a countermeasure.

For example, it can be provided that as monitoring criterion the number of the delivered coins or bank notes is evaluated for each denomination value. The idea behind this is that for example in the case of a payment with coins, a number of coins is inserted for each denomination value, i.e. for each nominal amount of a coin, wherein with reference to the inserted number of coins for a denomination value it can be checked whether a maximum admissible number for the denomination value is exceeded. In this way it can be determined, for example, how many 1-Euro coins, 2-Euro coins or 10-Cent coins are inserted. For example, when the number of the inserted 1-Euro coins exceeds the maximum admissible number of 1-Euro coins, this is registered correspondingly and possibly a countermeasure is initiated.

In this connection, the maximum number of the delivered coins or bank notes can be different for each denomination value. For example, the maximum admissible number of 10-Cent coins can be greater than the maximum admissible number of 2-Euro coins. The maximum admissible number possibly can be configured freely by a user at a payment device for each denomination value.

The maximum admissible number for a denomination value also can depend on the amount to be paid. For a large amount to be paid, for example, the maximum admissible number for a denomination value can be greater than for a small amount to be paid.

As an additional or alternative monitoring criterion, the ratio of the paid, second amount and the payable, first amount also can be evaluated. The evaluation can be made by determining a ratio (division) or by determining a difference (subtraction) between the paid and the payable amount. With reference to the ratio of the paid amount and the payable amount it then is checked whether the ratio exceeds a maximum admissible overpayment factor. When the paid amount is greater than the payable amount by a factor which exceeds the overpayment factor, this is registered and possibly a countermeasure is initiated.

As additional or alternative monitoring criterion, there can also be evaluated a locally or regionally occurring payment behavior at a payment device or at a plurality of different payment devices. When it is noted, for example, that in a region, for example at payment devices within an urban area (e.g. within Berlin), within a certain period (e.g. within a week), unusual payment operations occur to an increased extent, this can be registered and possibly a countermeasure can be initiated. Unusual payment operations for example can consist in that payment operations to an increased extent are effected with coins or bank notes of a certain denomination value. When a plurality of comparable payment operations occur at different payment devices in a region within a short time, this can point to the fact that it is attempted in a criminal way to exchange counterfeit money for real money.

For this purpose, a plurality of payment devices advantageously are communicatively cross-linked with each other, so that as monitoring criterion for example the payment behavior at different payment devices within a network can be evaluated.

In dependence on the evaluation of the payable amount and/or the paid amount with reference to monitoring criteria, a countermeasure is initiated, in order to preventively inhibit a money laundering attack. The countermeasure for example can be initiated when the evaluation of only one monitoring criterion reveals that there is a risk of a money laundering attack, for example because a maximum admissible number of inserted coins for a denomination value or an overpayment factor is exceeded. Advantageously, however, a plurality of monitoring criteria are to be evaluated cumulatively, wherein a countermeasure only is initiated when the examination with reference to the plurality of monitoring criteria reveals that there is a risk of a money laundering attack. Thus, a countermeasure for example can only be initiated when the number of the coins or bank notes for a denomination value used for a payment operation exceeds a maximum admissible number for this denomination value and in addition the ratio of the paid amount and the payable amount exceeds a maximum admissible overpayment factor.

As countermeasure, different measures are considered in principle, wherein a single measure or also a plurality of measures in combination can be taken. For example, the disbursement of a change amount resulting from the difference of the paid, second amount and the payable, first amount cannot be made, so that when there is a risk of a money laundering attack, the change money will no be disbursed. Alternatively or in addition, a camera device can be activated for recording the user, an acoustic alarm can be triggered and/or a message for alerting supervising personnel can be generated by means of a communication means. Other measures are also conceivable. For example, the acceptance of a concerned type of coin of a certain denomination value can be blocked, so that a customer is not able to e.g. pay with 1-Euro coins, when the number of 1-Euro coins inserted already exceeds the maximum admissible number of 1-Euro coins or when within a region an increased payment with 1-Euro coins in different payment operations is detected.

The object in addition is solved by a payment device for carrying out a payment operation for carrying out a method for the prevention of money laundering attacks. The payment device includes a control means which is formed to determine a first amount to be paid in connection with a payment operation and a second amount which is paid by a user at a paying means of the payment device by delivery of cash. It is provided in addition that the control device is formed to evaluate the payable, first amount and/or the paid, second amount with reference to at least one monitoring criterion, to infer a possible money laundering attack in dependence on the evaluation, and to initiate a countermeasure.

The advantages and advantageous aspects described above for the method are also applicable analogously to the payment device, so that reference is made to the above explanations. The payment device advantageously is designed for carrying out a method for the prevention of money laundering attacks of the type described above.

### BRIEF DESCRIPTION OF THE DRAWINGS

The idea underlying the invention will be explained in detail below with reference to the exemplary embodiments illustrated in the Figures.

FIG. 1 shows a schematic view of a payment device for carrying out a payment operation.

FIG. 2 shows a schematic flow diagram of an exemplary embodiment of a method for the prevention of money laundering attacks at a payment device.

FIG. 3 shows a schematic view of a first payment device which is cross-linked with further payment devices in a network.

### DETAILED DESCRIPTION

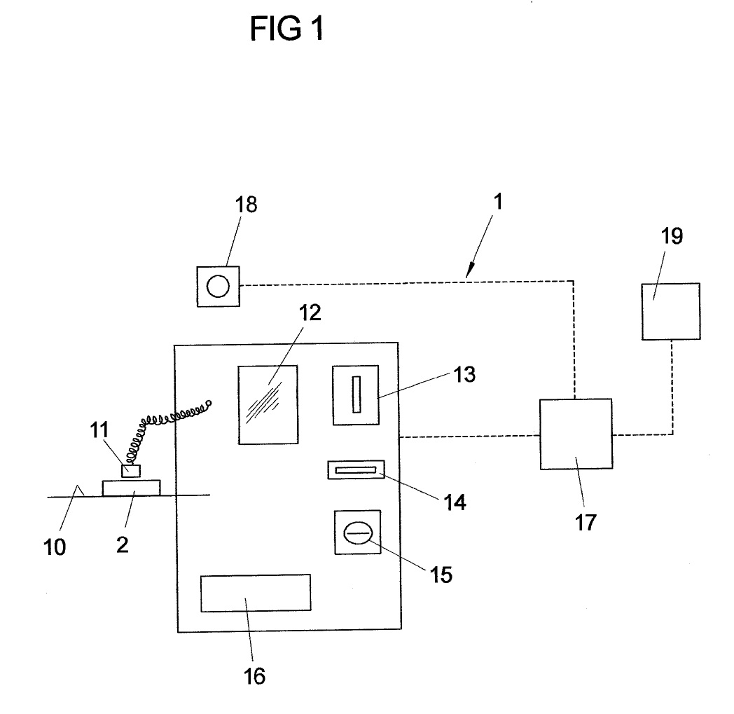

FIG. 1 shows a schematic view of a payment device 1 in the form of a so-called self-checkout machine, at which goods 2 can be detected by a customer by means of a detection means 11 in the form of a reader for example for reading in a bar code. The payment device 1 comprises a shelf 10 for depositing goods 2, a screen 12 for displaying the detected goods 2 and an amount of money to be paid, a paying means 13 in the form of a coin insertion means for inserting coins, a paying means 14 in the form of a bank note insertion means for inserting bank notes, a means 15 for making cashless payments for example by means of a credit card or a debit card and a cash dispensing means 16 for giving change.

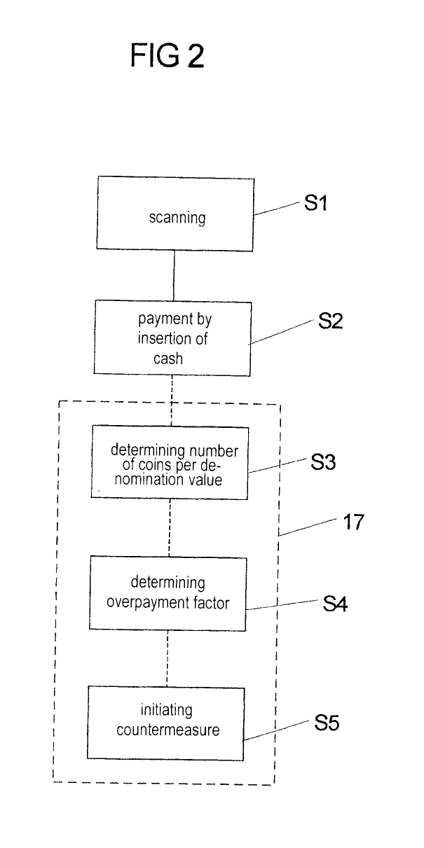

For carrying out a payment operation by means of the payment device 1, a customer for example reads in a bar code of a merchandise 2 deposited on the shelf 10 by means of the detection means 11. A designation of the detected merchandise 2 is displayed on the screen 12, and the customer is given the opportunity to read in further goods 2 or to initiate a payment operation for paying the goods 2. This is shown in the schematic flow diagram of FIG. 2 in the steps S1 and S2.

The payment operation can be effected by inserting coins into the paying means 13 or by inserting bank notes into the paying means 14, in order to pay the merchandise 2 with cash. Alternatively, it is also possible to make a cashless payment via the means 15 for example by means of a credit card or debit card.

The payment operation is controlled by a control means 17 of the device 1. The control means 17 for example controls the reading in of the goods 2 by means of the detection means 11, the displaying of goods designations, goods prices and a payable total amount on the screen 12 as well as the payment operation as such with cash at the paying means 13, 14 or cashless at the means 15.

During payment with cash via the paying means 13, 14, the control means 17 is designed to carry out a method for the prevention of money laundering attacks, as it is shown schematically in FIG. 2 in the steps S3-S5. In connection with this method, the number of the inserted coins or bank notes is determined for inserted coins or bank notes for each denomination value (step S3). In addition, an overpayment factor is determined by forming the ratio between the amount paid via the paying means 13, 14 and the payable amount corresponding to the total price of the goods 2 (step S4). With reference to the number of inserted coins or bank notes per denomination value it is checked whether the number of the coins or bank notes for a denomination value exceeds a maximum admissible number for this denomination value. For the overpayment factor it is checked whether the overpayment factor is greater than a maximum admissible overpayment factor. Depending on this examination, countermeasures then are possibly initiated in step S5, in that for example the disbursement of change is inhibited, supervising personnel is informed, an acoustic alarm is triggered or other measures are initiated.

A denomination value is understood to be a certain type of coin or bank note, for example a 1-Euro coin. The number of coins or bank notes per denomination value corresponds to the number of coins or bank notes inserted for a denomination value, for example to the number of inserted 1-Euro coins. When this number is greater than the maximum admissible number for the respective denomination value, this is registered and possibly a suitable countermeasure is initiated.

For example, in connection with a payment operation it can occur that an amount of 2.50 Euro is to be paid. Via the paying means 13, an amount of 50 Euro is paid in coins, e.g. with 20 2-Euro coins and ten 1-Euro coins. The number of coins for the denomination value “1 Euro” thus is 10, the number for the denomination value “2 Euro” is 20. When the maximum admissible number for the denomination value “1 Euro” for example is 12 and the maximum admissible number for the denomination value “2 Euro” is 18, the maximum admissible number for the denomination value “2 Euro” is exceeded, which is registered correspondingly.

In the above example, the overpayment factor is 20 (50 Euro divided by 2.50 Euro). When the maximum admissible overpayment factor for example is 5, the maximum admissible payment factor also is exceeded in this case, which likewise is registered correspondingly.

The maximum admissible number for a denomination value can be chosen freely in principle and possibly also be configured by a user in the desired way at a payment device.

The maximum admissible overpayment factor also can be chosen freely in principle and be configured at a payment device. For example, it is also conceivable that the maximum admissible overpayment factor varies in dependence on a merchandise to be paid or an industry segment in which the payment operation takes place. For example, in a payment operation in an electronics shop a higher overpayment factor can be admissible than in a newspaper kiosk.

The maximum admissible number of coins or bank notes per denomination value can be different for different denomination values. The maximum admissible number for 1-Euro coins thus can differ from the maximum admissible number for 10-Euro notes, for example. It is likewise conceivable that the maximum admissible number is not static, but varies with the payable amount, so that for example with a payable amount of 10 Euro the admissible number for a denomination value is smaller than with a payable amount of 1000 Euro.

The same can be applicable for the maximum admissible overpayment factor.

The number of coins or bank notes per denomination value and the overpayment factor represent monitoring criteria, by means of which the payment operation is monitored with regard to a possible money laundering attack. There can already be inferred a possible money laundering attack, when an inadmissible exceedance is detected for a single monitoring criterion. Advantageously, however, a money laundering attacked will only be inferred when two monitoring criteria, i.e. an exceedance of the maximum admissible number for a denomination value and an exceedance of the maximum admissible overpayment factor, are detected, in order to exclude a false alarm, if possible.

In principle, all kinds of countermeasures are conceivable, which are able to effectively inhibit a money laundering attack. For example, when the disbursement of change by means of the money dispensing means 16 is inhibited, the customer will receive no change and thus in the case of a true money laundering attack no real money for inserted counterfeit money. The money laundering attack thus is prevented.

Other measures for example can consist in that supervising personnel is informed, which can be effected by an acoustic alarm or by means of a communication means 19 (see FIG. 1), which is actuated by means of the control means 17 and for example is designed to send a message, for example an SMS, an e-mail or another telecommunication message, to a competent body.

Likewise, the control means can be designed to actuate a camera device 18 (see FIG. 1), in order to activate the camera device 18 in the case of a risk for a money laundering attack, so that a potential offender is recorded.

A countermeasure also can consist in that an exit of a building is actuated, for example to close an exit door and prevent leaving of the building, when a possible money laundering attack is detected.

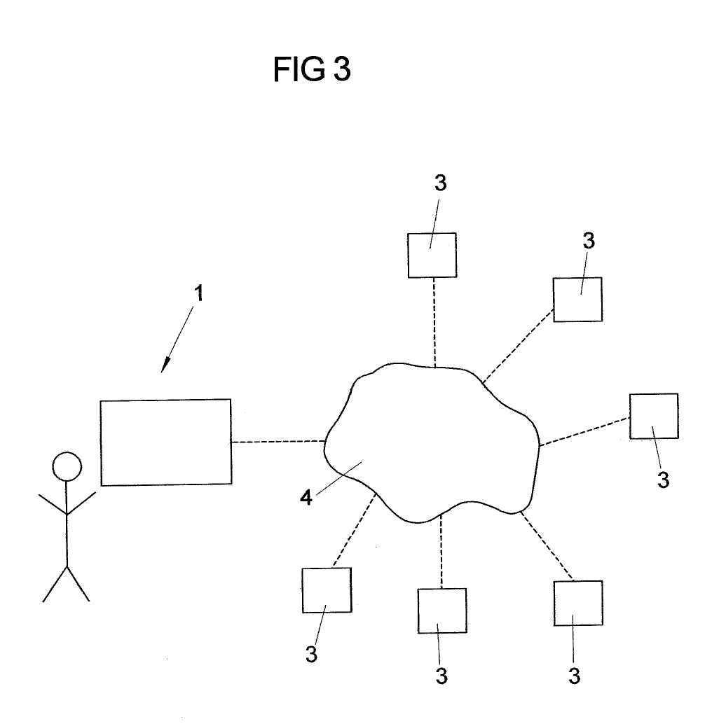

FIG. 3 shows a schematic view of a payment device 1 which is in communicative connection with other payment devices 3 via a network 4. The network 4 can be configured as a separate, private communication network which exclusively connects the payment devices 1, 3 with each other for an electronic data communication. It is, however, also conceivable and possible that the communication between the payment devices 1, 3 is effected via a public network, for example the Internet.

When the payment device 1, as schematically shown in FIG. 3, is connected with other payment devices 3 via a network 4, it becomes possible to also evaluate payment operations at other payment devices 3 as monitoring criterion, in order to infer an increased amount of unusual payment operations from such payment operations, which for example have occurred within a region within a particular preceding period.

For example, when it is noted in a payment operation performed at the payment device 1 that this payment operation resembles other payment operations which have been performed at other payment devices 3 in a preceding period and reveals unusual conspicuities, the existence of a money laundering attack can be inferred therefrom. For example, when it is noted in a payment operation at the payment device 1 that a payable amount is paid with a large number of 1-Euro coins (but for example an overpayment factor is not exceeded and thus, according to the settings at this payment device 1, no countermeasure actually would have to be initiated) and at the same time in preceding payment operations at the same payment device 1 or at other payment devices 3 an unusually increased amount of payment operations has occurred within a preceding, predetermined period, for example one week, in which payment has been made with a large number of 1-Euro coins, it can be inferred therefrom that counterfeit money in the form of 1-Euro coins should be put into circulation. Thus, a money laundering attack can be inferred, and corresponding countermeasures, for example alerting competent bodies or inhibiting a payment operation, can be effected.

Thus, local and time factors also can be considered as monitoring criteria, in that payment operations at payment devices 1, 3 within a region, for example within an urban area, are evaluated, as far as they have taken place within a predetermined period before the intended payment operation.

The idea underlying the invention is not limited to the exemplary embodiments described above. In particular, a method for the prevention of money laundering attacks as described here is not limited to the use at self-checkout machines. Such methods expediently can be used at all those devices which provide for a payment operation with cash, for example at ticket machines, cigarette machines, vending machines, drinks dispensers or the like.

### LIST OF REFERENCE NUMERALS

1 payment device
10 shelf
11 detection means
12 screen
13 paying means (coin insertion means)
14 paying means (bank note insertion means)
15 means for cashless payment
16 money dispensing means
17 control means
18 camera device
19 communication means
2 merchandise
3 further payment devices
4 network
S1-S5 steps

1. A method for the prevention of money laundering attacks at a payment device, in which
a control means of a payment device determines a first amount to be paid in connection with a payment operation,
a second amount is paid by a user at a paying means of the payment device by delivery of cash, and
the control means detects the paid, second amount,
wherein the control device evaluates the payable, first amount and/or the paid, second amount with reference to at least one monitoring criterion, infers a possible money laundering attack in dependence on the evaluation, and initiates a countermeasure.

2. The method according to claim 1, wherein the second amount is paid in the form of coins or bank notes, wherein as monitoring criterion for delivered coins or bank notes the number of the delivered coins or bank notes is evaluated for each denomination value.

3. The method according to claim 2, wherein a countermeasure is initiated when the number of the delivered coins or bank notes for a denomination value exceeds a maximum admissible number for the denomination value.

4. The method according to claim 1, wherein as monitoring criterion the ratio of the paid, second amount and the payable, first amount is evaluated.

5. The method according to claim 4, wherein a countermeasure is initiated when the ratio of the paid, second amount and the payable, first amount exceeds a maximum admissible overpayment factor.

6. The method according to claim 1, wherein as monitoring criterion different payment operations within a predetermined period at the concerned, first payment device and/or at further payment devices different from the concerned, first payment device, which are in communication connection with the first payment device, are evaluated.

7. The method according to claim 1, wherein a countermeasure only is initiated when the number of the delivered coins or bank notes for a denomination value exceeds a maximum admissible number for the denomination value and the ratio of the paid, second amount and the payable, first amount exceeds a maximum admissible overpayment factor.

8. The method according to claim 1, wherein as countermeasure
a disbursement of a change amount resulting from the difference of the paid, second amount and the payable, first amount is omitted,
a camera device is activated for recording the user,
an acoustic alarm is triggered,
and/or by means of a communication means a message is generated for alerting supervising personnel.

9. A payment device for carrying out a payment operation for carrying out a method for the prevention of money laundering attacks, comprising a control means which is formed to determine a first amount payable in connection with a payment operation and detect a second amount which is paid by a user at a paying means of the payment device by delivery of cash, wherein the control device is formed to evaluate the payable, first amount and/or the paid, second amount with reference to at least one monitoring criterion, to infer a possible money laundering attack in dependence on the evaluation, and to initiate a countermeasure.
